(19) United States
(12) Patent Application Publication
(10) Pub. No.: US 2019/0043632 A1
(43) Pub. Date: Feb. 7, 2019

(54) Light-Nuclei Element Synthesis

(71) Applicant: Nex-Gen Solar Technologies, LLC, Fort Lauderdale, FL (US)

(72) Inventor: Mathew M. Zuckerman, Carbondale, CO (US)

(21) Appl. No.: 16/052,146

(22) Filed: Aug. 1, 2018

Related U.S. Application Data
(60) Provisional application No. 62/539,910, filed on Aug. 1, 2017.

(51) Int. Cl. G21G 1/12; G21G 1/00

(52) U.S. Cl. CPC G21G 1/12; G21G 2001/0094; G21G 1/001

(57) ABSTRACT

A system and method for the synthesis of light-nuclei elements (LNEs), including the battery element Lithium, in high-purity form. The method eliminates the need for high-energy proton collision in Cosmic Rays to produce Nitrogen-15. LNEs are produced by placing a mixture with carbon, nitrogen, and oxygen (CNO) source material in a strong, fixed magnetic field, then introducing instability to the CNO's stable isotopes through high-frequency radio waves tuned to the nuclear magnetic resonance (NMR) frequency of a target material in the mixture to produce a LNE product material, and then separating the LNE product material from other materials within the mixture by enhancing gravity separation based on the opposite signs of respective dipole magnetic moments (DMM) to cause attraction of the product material, such as Lithium, to the South magnetic pole away from another product material, such as Beryllium, that is attracted to the North magnetic pole.

### RELATED APPLICATION

This application claims priority to Provisional Application No. 62/539,910, filed Aug. 1, 2017, which is incorporated herein by reference.

### FIELD OF INVENTION

The present invention relates specifically to the generation of the light-Nuclei elements (LNEs) Lithium, Beryllium and Boron by the process of low energy fission, breaking down, Carbon, Nitrogen, and Oxygen (CNOs) with the introduction of instability to the CNOs heavy stable isotopes through the application high-frequency radio waves at the NMR frequency, in the presence of a strong magnetic field, of the targeted source material. The present invention achieves a separation of a mixture of materials employing an axial facing inward LaPlace Force generated by the confining strong magnetic field that surrounds the mixture and the differences in signs of the respective dipole magnetic moments of the target component from the dominant bulk component of the mixture, to augment the difference in specific gravity of each component and enhance gravity separation.

### BACKGROUND OF THE INVENTION

Lithium is much like petroleum in that the energy released from combustion of one kilogram of gasoline is the same amount as the stored cell energy released from one kilogram of lithium: 10 kilowatt hours. The addition of other materials to the typical Lithium battery make the battery many times heavier than just the weight of the Lithium.

In June 2016, it was predicted for Lithium that “Prices are going stratospheric . . . investment websites are glowing red hot with speculation about the metal's prospect.” Fortune Magazine by Time, Inc. Fortune went further to predict, “Lithium could become the key material in the coming green revolution of storable energy.”

Under the present invention, Light-Nuclei Elements (LNEs), and specifically Lithium, are produced by first placing the Carbon, Nitrogen, and Oxygen (CNO) source materials in a strong fixed magnetic field. As used herein, a strong magnetic field shall refer to a magnetic field with a magnetic field strength of at least one Tesla (T), that surrounds the mixture, then introducing instability to the CNO-stable isotopes through the application high-frequency radio waves at the nuclear magnetic resonance (NMR) frequency of the targeted source and/or product material, and finally separating the LNE product from the bulk by enhancing gravity separation based on the opposite signs of the respective Dipole Magnetic Moments (DMM) that causes attraction of one product to North magnetic pole away from another product that is attracted to the other opposite South magnetic pole.

Cosmic Production of Light-Nuclei Elements (LNEs). The abundance of elements in the Cosmos shows that Hydrogen and Helium are far more abundant than all other elements while there is a great under-abundance of the LNEs, Lithium, Beryllium, and Boron. In general, the abundance of an element present in our Sun is taken as the abundance of the element in the Cosmos since the Sun can be considered as a typical star. Lithium is the most abundant of the group of LNEs but is present in our Sun at the very low concentration of 4.5 atoms per million atoms of Silicon.

Hydrogen is converted to Helium directly, or through the Carbon-Nitrogen Cycle, at a temperature of about 18,000,000 degrees F. In the origin of elements, the nuclei of the LNEs could not withstand this high temperature required to form Helium, and the LNEs were bypassed by the production of Carbon from Helium.

Cosmic rays are high energy electrons and atomic nuclei that reach the Earth from all over the Cosmos. These cosmic rays contain LNEs at a far greater concentration than is contained in stars. This fact supports the theory that LNEs are produced as Cosmic rays journey to Earth. The light-Nuclei elements (LNEs), including the important battery element Lithium, are produced over light years of interstellar travel by cosmic-rays by breaking down Carbon, Nitrogen, and Oxygen (CNOs). The LNEs are formed after the occurrence of multiple collisions of slow moving neutrons, contained in the cosmic-rays, with the nuclei of CNOs.

FIG. 3 shows the most probable LNEs that form from the CNO source materials that result from the collision of neutrons during the travel of cosmic rays to the Earth. There are eighteen possible reactions between slow moving neutrons and the nuclei of Carbon and Oxygen. Carbon and Oxygen are present in the form of the molecule of Carbon Dioxide that contains one Carbon and two Oxygen elements. Seven of these possible reactions between slow moving neutrons and nucleus of Carbon are possible. Only one of these reactions produces Lithium. However, this reaction has the highest probability of occurring. Carbon 13, with mass 13, is the source material to produce both Lithium-6 with atomic mass number 6 and Lithium-7 with mass number 7. This reaction is depicted in FIG. 3 as the most probable reaction for the formation of Lithium with the source material as the heavy stable isotope of Carbon: Carbon-13.

Eleven of the above-referenced possible reactions occur between the Oxygen in Carbon Dioxide and slow-moving neutrons. Lithium is produced in only four of these reactions. However, two of these Lithium-producing reactions have the highest probability of occurring. These reactions are shown in FIG. 3 as the most probable reactions for the formation of Lithium with the source material being a heavier stable isotope of Oxygen: Oxygen-17. Lithium in both the Lithium-6 & Lithium-7 isotopes is produced in the reactions starting with either Oxygen-17 or Carbon-13 as the source material. However, the reaction of Oxygen-17 also produces Boron in both the Boron-10 and Boron-11 isotopes. Lastly, the reaction of slow-moving neutrons and Nitrogen is predicted and shown in FIG. 3 by extrapolation of the most probable reactions that were reported to occur for Carbon and Oxygen. Here, the source material is the heavier isotope of Nitrogen, Nitrogen-15, and the LNEs products are Lithium-6 and Beryllium-9.

Nuclear Magnetic Resonance. Illustrated in FIG. 4 are the workings of a device for the measurement of the Nuclear Magnetic Resonance (NMR), also known as Magnetic Resonance Imaging (MRI), by selective absorption of very high-frequency radio waves by certain atomic nuclei that are subject to an appropriately strong stationary magnetic field where nuclei act like tiny magnets. The strong magnetic field exerts a force that causes the nuclear magnet's precession in somewhat the same way as the access of a spinning top traces out a cone-shaped surface while the top's follows a precession in the Earth's gravitational field.

When the natural frequency of the nuclear magnet's precession corresponds to the frequency of a weak external radio wave striking the material, energy is absorbed by the nuclei from the radio wave. This selective absorption, called resonance or nuclear magnetic resonance (NMR), is produced either by tuning the natural frequency of the nuclear magnet to that of the weak radio wave of a fixed frequency or by tuning the frequency of the weak radio wave to that of the nuclear magnet. Because the absorption of energy occurs in fixed quantum or bundles, there are specific pairings of the strong stationary magnetic field and weak radio wave.

The specific pairs for stable isotopes of Carbon, Nitrogen and Oxygen (CNOs) are shown in FIG. 6. For magnetic fields of the order of magnitude of several kilo gauss, a gauss being a unit of magnetic intensity, NMR frequencies fall in the radio-frequency range or broadcast range. For example, the NMR frequency for Hydrogen, with one proton and no balancing neutron in the nucleus, is 42.58 megahertz in a stationary magnetic field of 10 kilo gauss. The number of revolutions of the nucleus detectable by magnetic resonance varies widely with the applied field, the temperature, the nature of the sample, and the nuclear species. Under the best conditions, the number of revolutions of the nucleus is an enormous and exceeds 1×10¹⁸ or some billion-billion revolutions.

In FIG. 4, the magnetic vector u of a spinning charge particle is depicted as lying along the axis of rotation. The surrounding magnetic field, symbolized by the vector H, exerts a torque that tends to bring u and H into alignment, but this torque also interacts with the angular momentum vector. The effect of this interaction is to cause the spin axis, and the magnetic moment vector, to undergo the so-called Larmor precession, that is, to describe a cone about the direction of the magnetic field. According to classical electrodynamics, the frequency W_{L} of the Larmor precession, the number of rotations per second of the vector u about the vector H, should be independent of the orientation angle Theta θ.

In magnetic-resonance devices, a weak oscillating field H′ is superimposed on a strong constant field H. This too is shown in FIG. 4. The vector of the oscillating field H′ rotates with an angular velocity w in a plane perpendicular to the direction of the strong field. If the rate of rotation w of the weak superimposed field H′ is synchronized with the Larmor frequency w_{L} of the nuclei's precession, the two rotating fields will be in phase and a steady force will act on the axis. In this situation, called resonance, the orientation angle and the associated magnetic state of the nuclei will suddenly change. When a system is raised to a higher state, energy is extracted from the superimposed fields, and vice versa. The use of an oscillating field to produce resonance is sometimes called “driving a resonance”.

Every experiment in magnetic resonance involves detecting the resonance. Nuclear magnetic resonance (NMR) makes use of electromagnetic detection in which energy liberated or absorbed in a transition is precisely that which is measured. In an NMR spectrometer, the amount of energy extracted from the superimposed fields is continuously measured and recorded on a strip chart while the frequency of the field is slowly varied. The resulting record, or spectrum, is ordinarily a straight line that indicates that the sample is absorbing no energy broken by peaks of resonance frequencies. Under typical experimental conditions, these peaks are narrow and the resonances are sharply tuned so that they appear as lines perpendicular to the flat trace obtained over the range of non-resonating frequencies. Using this technology, a magnetic resonance spectrometer measures the presence of a material based on the nuclear magnetic moment of the material. The magnetic resonance spectral lines are roughly analogues to the absorption and emission lines in optical spectrums.

Nuclear Magnetic Resonance (NMR) and Dipole Magnetic Moment (DMM). A strong, fixed magnetic field is required for both the application of high-frequency radio waves at the resonate frequency of the targeted nucleus to create NMR and to have elements separate by migrating to the opposite poles when their respective DMMs values have opposite signs. In the presence of a strong and static magnetic field, which produces a small amount of spin polarization, the application of a radio-frequency signal at the proper frequency induces a transition between states of spin. This “spin flip” places some of the spins in a higher energy state. A stable isotope can be destabilized when its energy is elevated to this higher energy state thereby making reactions possible that were impossible before the radio-frequency signal at the NMR frequency was applied.

An isotope placed in a strong, static magnetic field will be oriented and moved in the direction of either magnetic poles based on the sign, positive or negative, of the DMM value for the isotope. The two stable isotopes of Nitrogen have DMM values with opposite signs. Nitrogen-14 has a DMM of positive 0.40376, and Nitrogen-15 has a DMM value of negative 0.28318. When a mixture of both elements is placed in a strong, static magnetic field, the Nitrogen-14 will have a potential energy versus one magnetic pole that will tend to separate it from the mixture by migrating and concentrating to that pole and the Nitrogen-15 will have a potential energy versus the other magnetic pole that will tend to separate it from the mixture by migrating and concentrating to that other pole.

Abundance and World's Reserves and Production of Lithium. As shown in FIG. 3, the abundance of LNEs in the Earth's crust is 20 parts per million (ppm) for Lithium, 2 ppm for Beryllium, and 10 ppm for Boron. These quantities are far less than the metal Aluminum, which constitutes 8.1% (80,100 ppm) of the Earth's crust, or Iron, which constitutes 5.0% (50,000 ppm) of the Earth's crust.

One of the largest suppliers of Lithium with low cost of production is Chile's Sociedad Quimica y Minera SA (SQM), who more than doubled its Lithium revenue in Q3 2016, year over year. SQM also increased production of ore from 12,100 metric tons from 10,300 metric tons in Q3, quarter over quarter. The doubling of the year over year revenue derived from the combination of an increase in production and a 28% increase in price, year over year. The two principal ores are Lithium Carbonate, a hard rock that sold for $19 during 2017 per pound as Lithium, and Lithium Hydroxide, a salt that sold for $9.50 per pound as Lithium.

The ores of lithium and their average percent Lithium by weight are presented in Table I below:

TABLE I

| ORE | % Lithium |
|---|---|
| Spodumene | 3.73 |
| Lepidolite | 3.58 |
| Zinnwaldite | 1.59 |
| Amblygonite | 3.44 |
| Petalite | 2.09 |

The United States Geological Survey has estimated that the world's reserves of Lithium are 30,000,000 metric tons while worldwide production in 2014 was 33,600 metric tons. If the reserves are divided by the annual production, it can be calculated that there is a 900-year supply of Lithium. However, this snapshot approach is deceiving. On the supply side, the world's known reserves of low production cost Lithium Salts are geographically concentrated in the “Lithium Triangle” located in Bolivia, Argentina, and Chile. On the demand side, a notable spike is occurring associated the ramp up of mass production of the electric car. For instance, Tesla Inc.'s battery plant alone added approximately 15,000 metric tons to demand for Lithium in 2017 to produce 100,000 vehicles annually. This would represent roughly 50% of the world's 2014 production. Furthermore, large automakers Toyota, GM, VW, and Ford announced plans to morph production toward electric cars. Representative of this shift is VW with production of 10,000,000 cars in 2017, which announced their plan to produce 3,000,000 electric cars in 30 models by 2025.

Even if one considers only the increased demand for Lithium created by the largest automakers, the 2025 annual demand for Lithium is forecast to be 2,000,000 metric tons per year or 60 times the current rate of production. In view of the accelerating demand for Lithium, it is apparent that there is and will increasingly be a significant need for a process capable of producing a supply of Lithium from available source materials. Indeed, it is expected that, within roughly eight years from the present writing, Lithium will fuel a green revolution of stored energy, experiencing a 60-fold increase in annual production from 100,000 to 10,000,000 electric cars. Ideally, the source materials for Lithium production will be so abundant that these materials will be effectively inexhaustible with the prescription for features and benefits of Table II below.

TABLE II

| Local Manufacture | Eliminates Shipping Costs |
|---|---|
| Large Difference in Specific | Battery Lithium Purity by Low Cost |
| Gravity of Metals | Gravity Separation |
| Large Difference in Dipole | Eliminates Costly Second Stage |
| Moment of Metals | Purification |
| Source Heavy Nitrogen | Allows Low Cost Magnetics as Substitute |
| Exhibits Dipole Moment | for Cryogenic Distillation |
| Heavy Nitrogen Source | Eliminates Costly Nuclear Bombardment |
| Material Contains | of the Nucleus |
| Unbalance Neutron | |
| Source Materials are | Low Material Cost with Operating Cost |
| Abundant and Free in the | is Electric Power for the Magnetics |
| Atmosphere and Anaerobic | |
| Gases from Biomass | |

### SUMMARY OF THE INVENTION

With an appreciation of the foregoing, the present inventor set forth with the basic object of providing a production process operative to produce a ready supply of Lithium from available source materials.

A more particular object of embodiments of the invention is to provide a production process capable of yielding a high quality, stably priced supply of Light-Nuclei Elements (LNEs) in general and Lithium in particular.

Another particular object of embodiments of the invention is to provide a production process capable of harvesting Light-Nuclei Elements (LNEs) in general and Lithium in particular in a production location having greater coincidence with the location of demand.

An underlying object of embodiments of the invention is to provide such a production process to support and fuel the accelerating green revolution in storable energy.

It is a further object of embodiments of the invention to provide a production process that obviates the need for the production of LNEs in interstellar space by collision with Carbon, Nitrogen, and Oxygen (CNOs) wherein slow-moving neutrons originating in cosmic rays are captured.

It is a further object of the invention in particular embodiments to provide a production process operative to yield Lithium in a form sufficiently pure to render unnecessary further processing operations prior to use as battery grade Lithium.

Embodiments of the invention have the more particular object of producing LNEs by the introduction of instability through the application of resonant nuclear magnetic (NMR) frequencies that cause instability to stable isotopes of CNOs.

A still more particular object of manifestations of the invention is to produce concentrated Nitrogen-15 from atmospheric air by inducing a dipole magnetic field to separate the rare element, Nitrogen-15, from its abundant element, Nitrogen-14, by migration to the opposite magnetic poles without requiring the energy intensive and costly process of cryogenic distillation.

In certain embodiments, a further object is to surround the source material with a strong, fixed magnetic field to create instability in the source materials by applying high-frequency radio waves at the NMR frequency of the targeted nucleus to accomplish separation of products produced from source material with gravity separation augmented by the product's opposite sign DMMs so that migration of products to opposite poles occurs.

It is another particular object of manifestations of the present invention to combine Carbon-13 and Oxygen-17 to form Dry Ice for use as a source material to produce LNEs.

It is another and further object of certain practices of the present invention to produce rare LNE's from less abundant stable isotopes of source material CNOs with nuclei-containing neutrons unbalanced by the number of protons.

Still another object of embodiments of the invention is to produce a higher percentage of light Lithium-6 than typically-mined terrestrial Lithium to enhance energy storage per unit weight by increasing electron mobility though a reduction in nuclear attractive force.

Yet another object of embodiments of the invention is to provide a source of Nitrogen-15 gas produced during anaerobic or aerobic decomposition of liquid or solid waste where the Nitrogen-15 to Nitrogen-14 ratio by weight is greater than the ratio typically found in the Earth's atmosphere.

These and further objects and advantages of embodiments of the invention will become obvious not only to one who reviews the present specification and drawings but also to one who has an opportunity to witness the method disclosed herein and the results thereof in practice. It will be appreciated, however, that, although the accomplishment of each of the foregoing objects in a single embodiment of the invention may be possible and indeed preferred, not all embodiments will seek or need to accomplish each and every potential object and advantage. Nonetheless, all such embodiments should be considered within the scope of the invention.

In an exemplary embodiment of the present invention, source material is a heavy form of Nitrogen present in the Earth's Atmosphere that is made unstable by delivering magnetic energy. The magnetic energy so delivered may be analogized to an opera singer breaking a crystal glass goblet. However, unlike the shattering of the goblet, unstable Nitrogen reforms into two stable elements of lighter weight, namely Beryllium and Lithium, as is schematically illustrated in Table III below.

TABLE III

| | |
|---|---|
| ¹⁵N (Nitrogen-15) [symbol] | ⁶Li (Lithium-6) |
| | ⁹Be (Beryllium-9) |

In such embodiments, chosen for the terrestrial synthesis of Beryllium and Lithium, is the reaction where Nuclear Magnetic Resonance (NMR) of reactants is sufficiently different to allow external magnetics to enrich heavy Nitrogen of biological origin to eliminate the need to duplicate one of the cosmic reactions. Each material may be addressed separately to apply magnetic energy in a non-contact method, and reactants are separated to mimic the separation that occurs in Earth's magnetic field with Beryllium deposited in the northern hemisphere and Lithium deposited in the southern hemisphere.

The Strong Nuclear Force (SNF) attractive force between positive charged nucleons, namely protons, is a maximum at 1.0 femtometers (10⁻¹⁵ meters) distance, and the Electrostatic Repulsion Force (ERF) repulsive force becomes dominant as the distance between the positive charged proton nucleons compresses to 0.8 femtometers. The reactants are compressed in both Beryllium/Lithium Synthesis and in Nuclear Fusion by applying energy through the orthogonal positioned poloidal and toroidal magnetic fields in a Tokamak Reactor.

Peers reviewing this invention have often concluded essentially that, ‘This is an impossible thing for this nuclear reaction to takes place in the atom's nucleus to result in elemental change, 10⁸ KJ/mol. This takes five orders of magnitude greater energy than a chemical reaction that consumes only a maximum energy of 10³ KJ/mol.’ In response, the present inventor points out that, for fusion, there is a requirement for enormous energy input, sourced from magnetics, to overcome the ERF repulsive force of positive charged proton bringing mass sufficiently proximate for fusion to occur. However, these same EFR repulsive forces can be harnessed in the Beryllium/Lithium Synthesis embodiment of this invention and in other embodiments to supplement only a modest amount of energy input from magnetics for the elemental changes to occur through Autogenesis Fission to produce an elemental change from Nitrogen-15 to synthesize Beryllium-9 and Lithium-6. With the aid of Magnetics, the distance between protons is compressed to a point of separation where the ERF repulsive force exceeds the SNF attractive force to exert a force equal to or greater than 10⁸ KJ/mol.

Embodiments of the present invention employ potentially all of the following to manufacture light-nuclei elements (LNEs), Lithium, Beryllium, and Boron, by breaking down Carbon, Nitrogen, and Oxygen (CNOs):

Use as source materials the less abundant stable isotopes of CNOs that have nuclei that contain the number of neutrons that is unbalanced by an equal number of protons;

Introduce instability to the CNOs stable isotopes through the application high-frequency radio waves at the NMR frequency of the targeted CNO source material;

Adopt a geometric configuration, one particular such geometric configuration being shown in FIG. 1, that places the CNO source materials in a strong, fixed magnetic field located orthogonal to intelligent NMR signal(s) and a subsystem that maintains the source material and product materials at constant temperature; and

Harness the axial facing inward Laplace Force that is generated by the confining strong magnetic field 12 that surrounds the mixture and the differences in signs of the respective dipole magnetic moments of the target component from other components of the mixture to augment the difference in specific gravity of each component to enhance gravity separation.

With additional reference to FIGS. 2A and 2B, the Lithium produced in accordance with the present invention is, unlike mined sources of Lithium, of high purity and does not require, for instance, separation of Lithium from ore having a single-digit concentration of Lithium. Just like in the production of Aluminum, the greatest cost material required to produce Lithium is electricity. However, unlike mined sources of Lithium, Lithium produced according to the present invention is pure and does not require separation of Lithium for either the Carbonate or the Lithium Hydroxide salt. Further, the Lithium produced has been calculated to set a new, higher standard of 13.2% greater energy storage per unit weight of Lithium because electrons are more easily released from 100% of the lighter form Lithium-6 rather than mined terrestrial Lithium 92.5% of which is the heavier form of Lithium-7.

In a preferred embodiment of the present invention, the LNEs of Lithium and Beryllium are produced first by placing stable Nitrogen-15 in a surrounding strong, fixed magnetic field, then applying high-frequency radio waves at the NMR frequency that destabilizes Nitrogen-15 to change the Nitrogen-15 into liquid Urea by reacting the Nitrogen-15 with anaerobic process produced Carbon Dioxide, Hydrogen, and Ammonia, and then separating the Lithium and Beryllium products of Nitrogen-15 by enhancing gravity separation. Opposite signs of the respective dipole magnetic moments of Lithium and Beryllium cause attraction of the lighter Lithium to magnetic pole located at the top of the reaction vessel and away from the heavier Beryllium product that is attracted to the opposite magnetic pole located at the bottom of the reaction vessel.

One practice of the method disclosed herein provides for the generation of light-nuclei elements (LNEs) and the separation of a mixture of materials containing the light-nuclei elements and carbon, nitrogen, and oxygen (CNO) source material with a strong magnetic field. The method is founded on providing at least one vessel for containing the mixture of materials with the mixture of materials including a source material. A fixed, strong magnetic field is provided that surrounds the at least one vessel, and a high-frequency radio wave signal is imparted to the mixture contained within the at least one vessel. The high-frequency radio wave signal is imparted at a fixed frequency corresponding to a resonant frequency of a targeted material within the mixture of materials to induce a resonance of the targeted material and an increased energy level in the targeted material within the mixture of materials. At least some of the targeted material is removed from the mixture of materials within the vessel as a light-nuclei element product material after resonance of the targeted material has been induced.

The at least one vessel can comprise a cylindrical vessel with a longitudinal axis, and the longitudinal axis of the at least one vessel can be disposed vertically. Similarly, the magnetic field can have a longitudinal axis, and the longitudinal axis of the magnetic field can be aligned with the longitudinal axis of the at least one vessel. In use, the high-frequency radio wave signal is operative to induce a precession of the targeted material while the fixed, strong magnetic field is operative to produce an inward Laplace Force.

The step of removing at least some of the targeted material from the mixture of materials within the at least one vessel includes separation of materials within the mixture of materials in certain embodiments comprises separation based on differences in signs of dipole magnetic moments of materials within the mixture of materials in augmentation of differences in specific gravity of each component to enhance gravitational separation of the materials within the mixture of materials.

Embodiments of the system and method can further include regulating a temperature within the at least one vessel to a substantially constant temperature by operation of a circulating fluid system. The mixture of materials can be continuously introduced into the at least one vessel to initiate motion in a vortex pattern in the at least one vessel. Further, the step of removing at least some of the targeted material from the mixture of materials within the at least one vessel can involve continuously and uniformly removing targeted material aided by the dipole magnetic moment of the targeted material within the mixture of materials. Still further, residual material can be continuously and uniformly removed from the mixture of materials within the at least one vessel aided by differences in dipole magnetic moments of the targeted material and the residual material.

The light-nuclei element product material can comprise Lithium-6 and Lithium-7 and Boron-10 and Boron-11, and the source material can comprise Carbon-13 and Oxygen-17. The high-frequency radio wave signals can be imparted at corresponding nuclear magnetic resonant frequencies for the source material.

In particular embodiments, it is contemplated that the Carbon-13 and Oxygen-17 can be in the form of Dry Ice with a density increased by a Laplace Force generated by the strong magnetic field operative to allow continuous exposure of the Dry Ice to high-frequency radio wave energy at the nuclear magnetic resonant frequencies of the Carbon-13 and Oxygen-17.

As disclosed herein, the step of removing at least some of the targeted material from the mixture of materials within the at least one vessel includes separation of materials within the mixture of materials comprises separation based on differences in signs of dipole magnetic moments of materials within the mixture of materials in augmentation of differences in specific gravity of each component to enhance gravitational separation of the materials within the mixture of materials. In particular, the differences in signs of dipole magnetic moments of materials within the mixture of materials can, for instance, comprise a difference in specific gravity of the Lithium-6 & Lithium-7 and Boron-10 & Boron-11 of 77.3%, and all dipole magnetic moments of the materials within the mixture of materials could be positive. The Lithium-6 & Lithium-7 are driven upward in the direction of one magnetic pole of the fixed magnetic field, and the Boron-10 & Boron-11 are driven downward in the direction of an opposite magnetic pole of the fixed magnetic field.

Within the scope of the invention, the fixed magnetic field can have a strength of at least approximately 10 kilo gauss, and the high-frequency radio wave signal can be provided by a high-frequency signal generator located above the vessel generated at approximately 5.72 MHz, the NMR frequency for Oxygen-17, and by a high-frequency signal generator located below the vessel generated at approximately 10.705 MHz, the NMR frequency for Carbon-13.

In practices of the method, the mixture of materials includes Nitrogen-15, and the high-frequency radio wave signal is operative to induce a quantum jump of the Nitrogen-15 at a discrete pairing combination of a resonant nuclear magnetic frequency range between 1.000 MHz to 4.314 MHz range and a strong magnetic field of below 10,000 Gauss.

Embodiments of the system and method are disclosed wherein the at least one vessel comprises a first vessel and a second vessel fluidically connected in series to the first vessel. In such embodiments, the source material comprises Nitrogen-15, and the Nitrogen-15 is separated and concentrated in the first vessel while the high-frequency radio wave signal is imparted to the Nitrogen-15 within the second vessel to produce Lithium-6 and Berrylium-9 as light-nuclei element product material.

The source material can comprise Nitrogen-15 from air in moisture free form reacted with Carbon Dioxide and Hydrogen produced by anaerobic processes to produce Urea 15N₂ in a liquid state. In other practices, the source material comprises Nitrogen-15 in gaseous form produced during anaerobic or aerobic decomposition of liquid or solid waste where the Nitrogen-15 to Nitrogen-14 ratio by weight is greater than the ratio found in the Earth's atmosphere.

It is contemplated still further that the source material can comprise Nitrogen-15 with the at least one vessel comprising a first vessel and a second vessel fluidically connected in series to the first vessel. The high-frequency radio wave signal can be provided by a high-frequency signal generator located below the first vessel. The high-frequency signal generator is tuned to the nuclear magnetic resonant frequency of Nitrogen-14 to be applied to an annulus-shaped cross section of the first vessel to exert a Laplace Force axial facing force that separates Nitrogen-15 and concentrates it in a central core of the first vessel. First and second Magnetrons are respectively located above and below the second vessel, and the first and second Magnetrons are tuned to the nuclear magnetic resonance of Nitrogen-15 to introduce instability to the Nitrogen-15 source material to produce Lithium-6 and Beryllium-9.

Where the at least one vessel comprises a first vessel and a second vessel fluidically connected in series to the first vessel, the first and second vessels can be surrounded by a fixed magnetic field with a strength of approximately 10 kilo Gauss. The high-frequency radio wave signal can be provided by a high-frequency signal generator located below the first cylindrical vessel to deliver energy at 3.076 MHz, the NMR frequency for Nitrogen-14, and a pair of high frequency signal generators can be located above and below the second vessel, each signal generator operative to deliver energy at 4.314 MHz, the NMR frequency for Nitrogen-15.

Again where first and second vessels are connected in series, the step of removing at least some of the targeted material from the mixture of materials within the at least one vessel can include separation of materials within the mixture of materials based on differences in signs of dipole magnetic moments of materials within the mixture of materials in augmentation of differences in specific gravity of each component to enhance gravitational separation of the materials within the mixture of materials wherein the differences in signs of dipole magnetic moments of materials within the mixture of materials. In the first vessel, while the difference in atomic weight of the Nitrogen-15 and Nitrogen-14 is 7%, a positive dipole magnetic moment of Nitrogen-14 of 0.40376 differs from a negative dipole magnetic moment of Nitrogen-15 of 0.28318 with a total difference in dipole magnetic moment of 0.68694 in dipole magnetic moments to augment separation by driving the Nitrogen-15 upward in the direction of one magnetic pole of the fixed magnetic field and driving the Nitrogen-14 downward in the direction of the other magnetic pole of the fixed magnetic field. In the second vessel, while the difference in specific gravity between Lithium-6 and Beryllium-9 is 71%, a positive dipole magnetic moment of Lithium-6 of 0.82204 differs from a negative dipole magnetic moment of Beryllium-9 of 1.1778 with a total difference in dipole magnetic moment of 1.99984 to augment separation by driving the Lithium-6 upward in the direction of one magnetic pole of the fixed magnetic field and driving the Beryllium-9 downward in the direction of the opposite magnetic pole of the fixed magnetic field. There, the mixture of materials can include Nitrogen-15, and the high-frequency radio wave signal is operative to induce a quantum jump of the Nitrogen-15 at a discrete pairing combination of a resonant nuclear magnetic frequency range between 1.000 MHz to 4.314 MHz range and a strong magnetic field of below 10,000 Gauss.

Still further, it is within the scope of the invention for the magnetic field to apply magnetic energy to heavy Nitrogen through orthogonally-positioned poloidal and toroidal magnetic fields. This operates to compress the distance between positive charged nucleons to a point of separation where Electrostatic Repulsion Force exceeds Strong Nuclear Force attractive force to exert a net force equal to or greater than 10⁸ KJ/mol.

The foregoing discussion broadly outlines certain more important advantages and features of the invention merely to enable a better understanding of the detailed description that follows and to instill a better appreciation of the inventor's contribution to the art. Before an embodiment of the invention is explained in detail, it must be made clear that the following details of construction, descriptions of geometry, and illustrations of inventive concepts are mere examples of the many possible manifestations of the invention.

### BRIEF DESCRIPTIONS OF THE DRAWINGS

It will be understood that the particular embodiments described and illustrated herein represent only potential manifestations of the invention and should not be interpreted to be limiting, except as may expressly be provided in the claims. To further clarify the foregoing and other advantages and features of the present invention, a more particular description of the disclosed method will be provided with reference to specific embodiments thereof as are described herein and shown in accompanying drawing figures, wherein:

FIG. 1 is a schematic depiction of a Strong Magnetic Field (SMF) that contains and is perpendicular to Resonant Nuclear Magnetic Fields;

FIG. 2A is a view in front elevation of 99% pure Lithium;

FIG. 2B is a schematic depiction of the atomic structure of Lithium-6;

FIG. 3 is a table showing the most probable LNEs that form CNO source materials resulting from the collision of neutrons during the travel of cosmic rays to Earth;

FIG. 4 is an operational schematic for a Magnetic Resonance Imaging (MRI) device for the measurement of Nuclear Magnetic Resonance (NMR) also known as Magnetic Resonance Imaging (MRI) by selective absorption of very high-frequency radio waves;

FIG. 5 is a table showing the specific characteristics of several source heavier-nuclei elements and stable isotopes of rare light-nuclei elements;

FIG. 6 is a table showing Resonant Nuclear Magnetic Frequency (RNMF) for source elements and stable isotopes and the Dipole Magnetic Moments (DMM) for elements and stable isotopes of interest;

FIG. 7A is a table showing the first three pairing combinations of Resonant Nuclear Magnetic Frequency (RNMF);

FIG. 7B is a graph of resonance as a function of Gauss in a Strong Magnetic Field (SMF);

FIG. 8A is a table depicting the predicted molar conversion of Nitrogen-15, Beryllium-9, and Lithium-6;

FIG. 8B is a graph of a magnetic catalyzed reaction with Resonant Nuclear Magnetic Frequency (RNMF) paired with a Strong Magnetic Field (SMF) in the ranges of magnetic spectroscopy and in the range of the present invention;

FIG. 9 is a schematic depiction of the use of a cylindrical vessel in a process for the manufacture of Lithium and Boron from source material comprising Carbon-13 and Oxygen-17;

FIG. 10A is a schematic depiction of the use of first and second cylindrical vessels used in a process for manufacturing Lithium-6 and Beryllium-9 from Nitrogen-15;

FIG. 10B is a cross section of the first cylindrical vessel taken along the line A-A in FIG. 10A;

FIG. 11A is a schematic depiction of first and second cylindrical vessels used in a process for manufacturing Lithium-6 and Beryllium-9 from Urea in the liquid state; and

FIG. 11B is a cross section of the first cylindrical vessel taken along the line A-A in FIG. 11A.

### DETAILED DESCRIPTION OF PREFERRED EMBODIMENTS

The systems and methods for light-nuclei element synthesis disclosed herein are subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

Magnetic Response of Source Materials and Manufactured Elements and Isotopes. As disclosed herein, Light-Nuclei Elements (LNEs), including Lithium, are produced by first placing Carbon, Nitrogen, and Oxygen (CNO) source materials in a strong, fixed magnetic field 12 that surrounds the mixture of materials. Then, instability is introduced to the stable isotopes of the CNOs through the application high-frequency radio waves by a high-frequency radio wave generator 18 tuned to the resonant NMR frequency of the targeted source and/or product material. The LNE product is separated from the bulk by enhancing gravity separation based on the opposite signs of the respective dipole magnetic moments (DMM) that cause attraction of the product to one magnetic pole and away from another product that is attracted to the opposite magnetic pole. Source material is separated from atmospheric air, and LNE products from each other, by enhancing gravity separation based on the opposite signs of the materials targeted for separation based on the DMM values for these materials to cause attraction of one material to one magnetic pole away from another material that is attracted to the other magnetic pole.

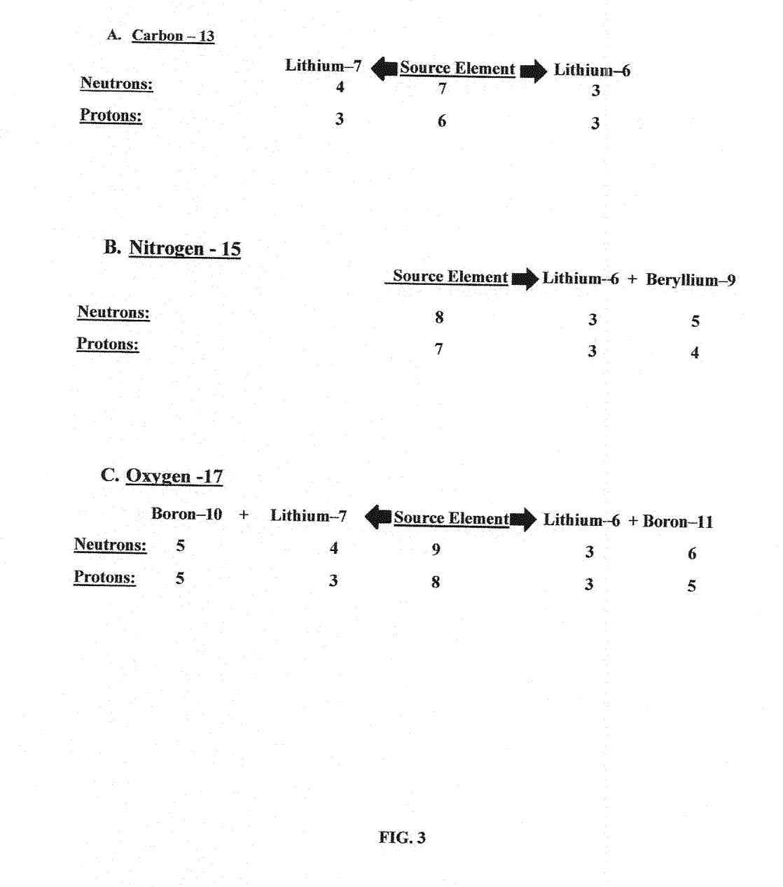

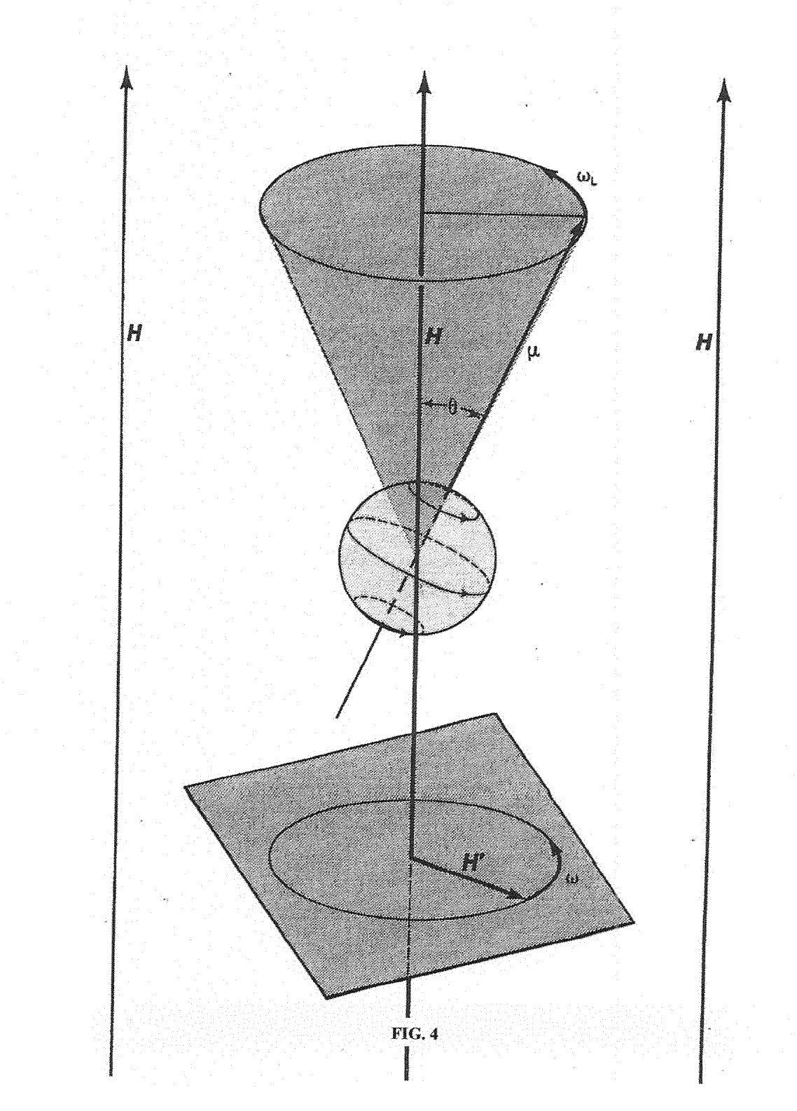

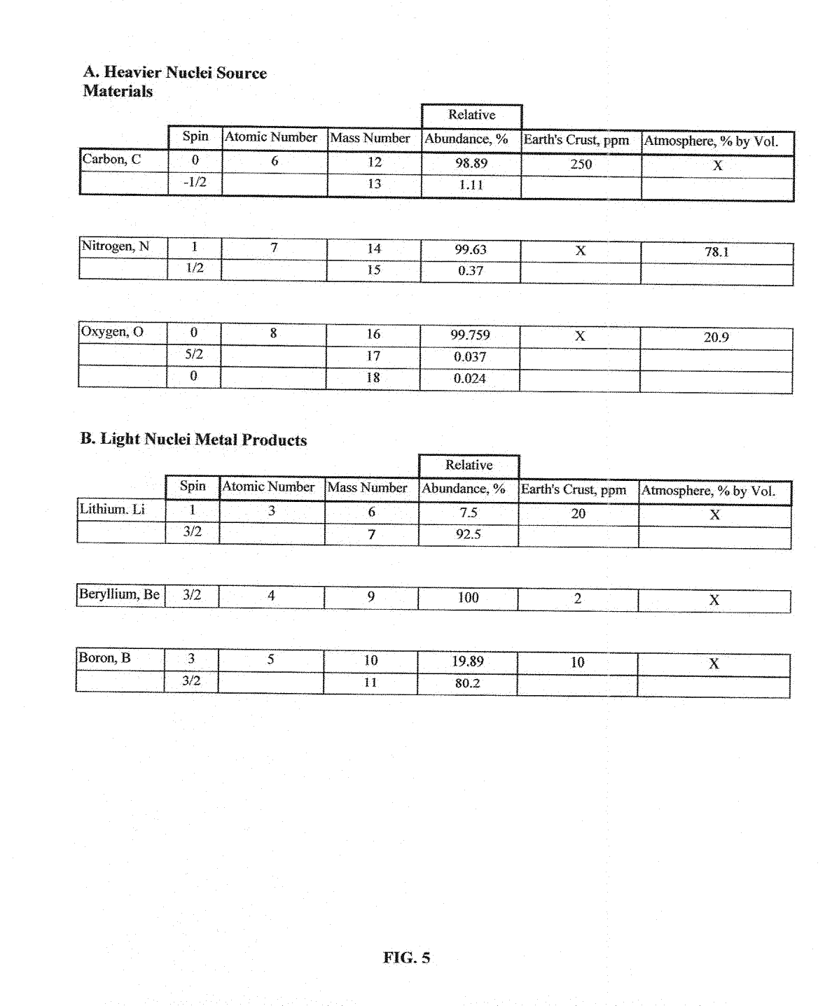

Shown in FIG. 5 are the specific characteristics of several heavier-nuclei elements and stable isotopes of rare light-nuclei elements. CNOs with nuclear spin values of zero, which are without significant NMR, cannot resonate when exposed to high-frequency radio waves for they lack asymmetry in their nuclei. Therefore, Carbon-12, Oxygen-16, and Oxygen-18 are disqualified as source materials for the present invention. Two of these disqualified source materials have the highest relative abundance: Carbon-12 with 98.9% of all Carbon and Oxygen-16 with 99.759% of all Oxygen. Possible choices for use under the present invention are the rarer isotopes of Carbon and Oxygen as source materials to produce LNEs, such as Carbon-13 with 1.11% relative abundance and Oxygen-17 with 0.037% relative abundance. However, these isotopes of Carbon and Oxygen are the same isotopes that were identified in FIG. 3 as the most probable reactants to produce LNEs. Thus, Carbon-13 and Oxygen-17 may be chosen as source materials to produce LNEs under the invention because both have NMR such that they are capable of being destabilized by high-frequency radio waves. They are reactant materials identified as the most probable to participate in the production of LNEs in the travel of cosmic rays to Earth.

Looking further to FIG. 3, one can perceive that Nitrogen-15 is the most probable reactant to produce LNEs. However, both Nitrogen-14 and Nitrogen-15 have non-zero values of spin with an associated NMR frequency response to high-frequency radio waves. Their respective NMR allows for the separation/concentration of Nitrogen-15 from atmospheric air since Nitrogen-14 is the principal component of atmospheric air with a concentration of over 77% by volume.

Looking again to FIG. 5, the abundance of the Carbon-13, Nitrogen-15, and Oxygen-17 source materials to produce LNEs can be understood. These source materials make up a small percentage of the abundance of the far more abundant elemental materials: Carbon-12, Nitrogen-14, and Oxygen-16. However, the abundance of these source materials, the product of the relative abundance of each and the total abundance in the Earth's crust and atmosphere, is still far greater than the abundance of the LNE's in the Earth's crust: Lithium with 20 ppm, Beryllium with 2 ppm, and Boron with 10 ppm.

The abundance of source materials is a differentiating consideration in choosing the preferred reactive materials under the present invention. In practice, the disclosed method parallels the reaction occurring in cosmic rays to produce LNEs. In this regard, it is known that Nitrogen-15 is the most abundant source material. That fact coupled with the fact that Nitrogen-14 has a non-zero spin and an associated NMR makes it the preferred source material for use under the present invention over Carbon-13 and Oxygen-17.

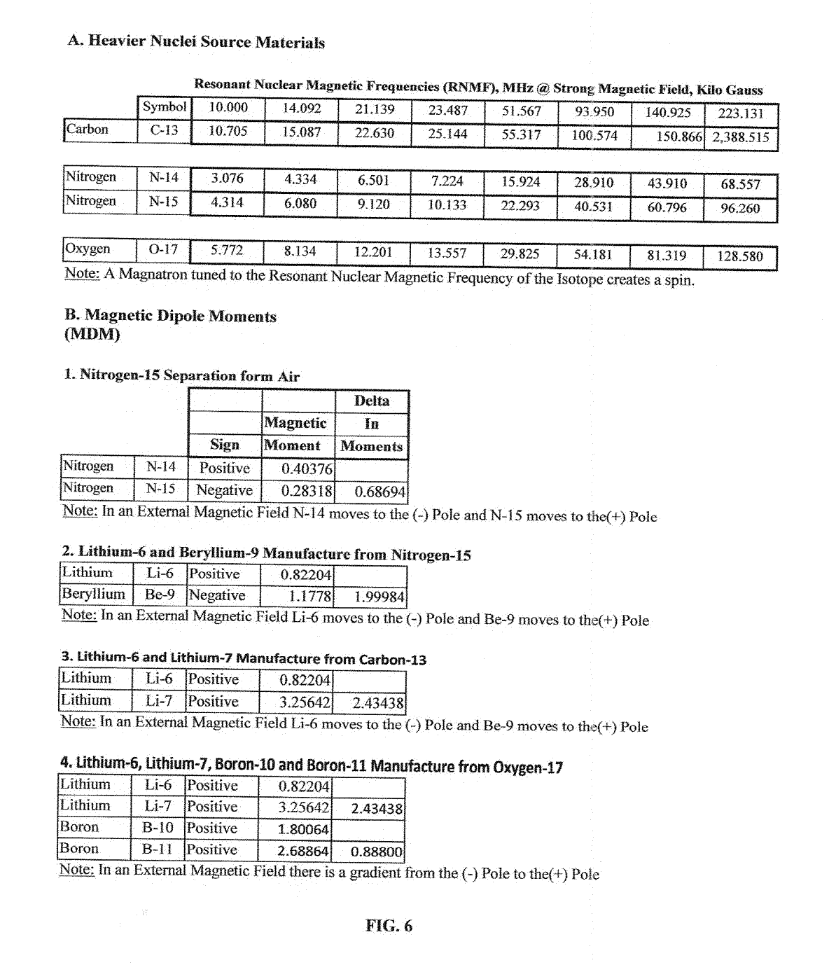

Shown in FIG. 6 are the nuclear magnetic resonant (NMR) frequencies for the source elements considered to be abundant and stable isotopes and dipole magnetic moments (DMM) for the elements and stable isotopes of interest. LNEs are produced when CNO source materials are placed in a strong, fixed magnetic field that surrounds the mixture to introduce instability into stable isotopes of CNOs through the application of high-frequency radio waves at their specific resonant frequencies. FIG. 6 lists the pairs of NMR frequencies of high-frequency radio waves that resonate with CNO isotopes when place in a strong magnetic field with strengths between approximately 10 Kilo Gauss and 233.131 Kilo Gauss.

A plurality of observations can be made based the table of FIG. 6. First, the NMR for all CNO isotopes increases with an increase in the strength of the strong magnetic field. Further, the NMR frequency of CNOs and the strong magnetic field in which resonance occurs are paired to specific values. Additionally, Carbon-13 has the highest NMR frequency required to achieve resonance at all values of the strong magnetic field. Finally, Nitrogen-14 with the lowest NMR frequency required to achieve resonance in a strong magnetic field will resonate at a similar frequency in a 51.567 Kilo Gauss strong magnetic field as Carbon-13 in a 14.092 Kilo Gauss strong magnetic field.

According to the present invention, the separation of source material from atmospheric air and LNE products from each other is accomplished by enhancing gravity separation based on the opposite signs of the respective DMM, which causes the attraction of material to one magnetic pole and away from another material that is attracted to the other magnetic pole.

Listed in FIG. 6 are groupings of Dipole Magnetic Moments designed to accomplish separation of the source material Nitrogen-15 from atmospheric air and the separation of LNE products from each other. These LNE products include Lithium-6 from Berrylium-9; Lithium-6 from Lithium-7; and the two isotopes of Lithium, Lithium-6 and Lithium-7, from the two isotopes of Boron, Boron-10 and Boron-11.

A plurality of observations can be made based on the table of FIG. 6. For instance, the signs of the DMMs are opposite pairings of atmospheric Nitrogen-14 from the source material Nitrogen-15 and for the LNE products Lithium-6 from Berrylium-9. Further, although the signs for the DMMs for the two isotopes of Lithium and Boron are both positive, the differences in values between the isotopes, 2.43438 and 0.88800, are sufficient to offer the possibility of separation of the isotopes in the strong, fixed magnetic field based on the gradient of field strength.

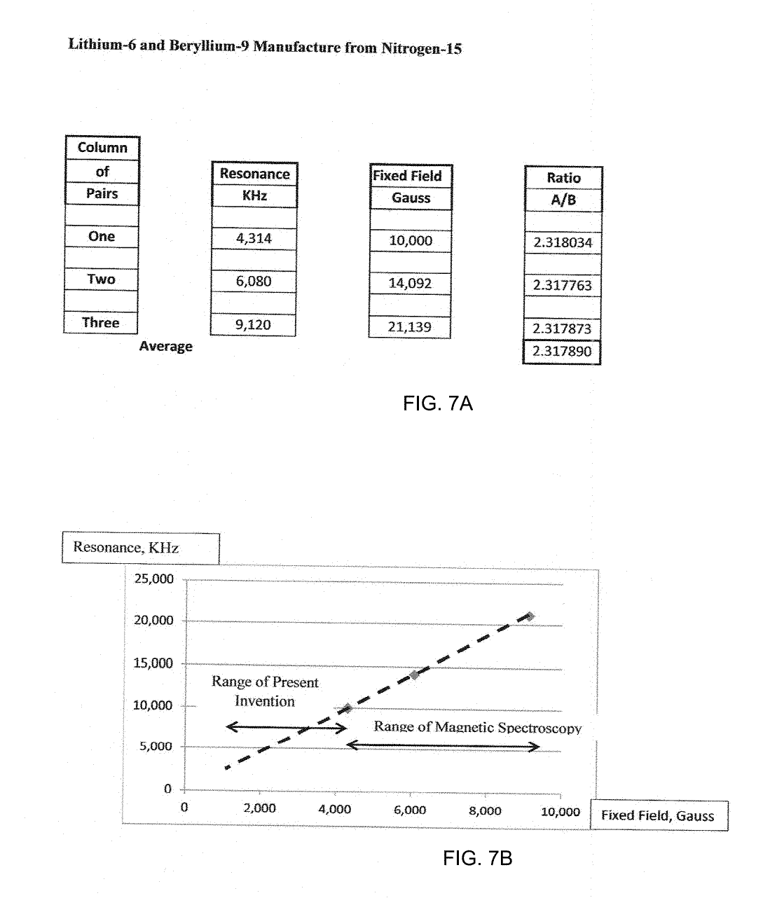

Magnetic Field Pairs. In a practice of the inventive method, as listed in FIG. 7, magnetics are designed to pair the following magnetic fields, that are oriented perpendicular to each other:

### Strength of Fixed Dipole Field, Tesla (K Gauss) Nitrogen-15 Resonant Freq., MHz

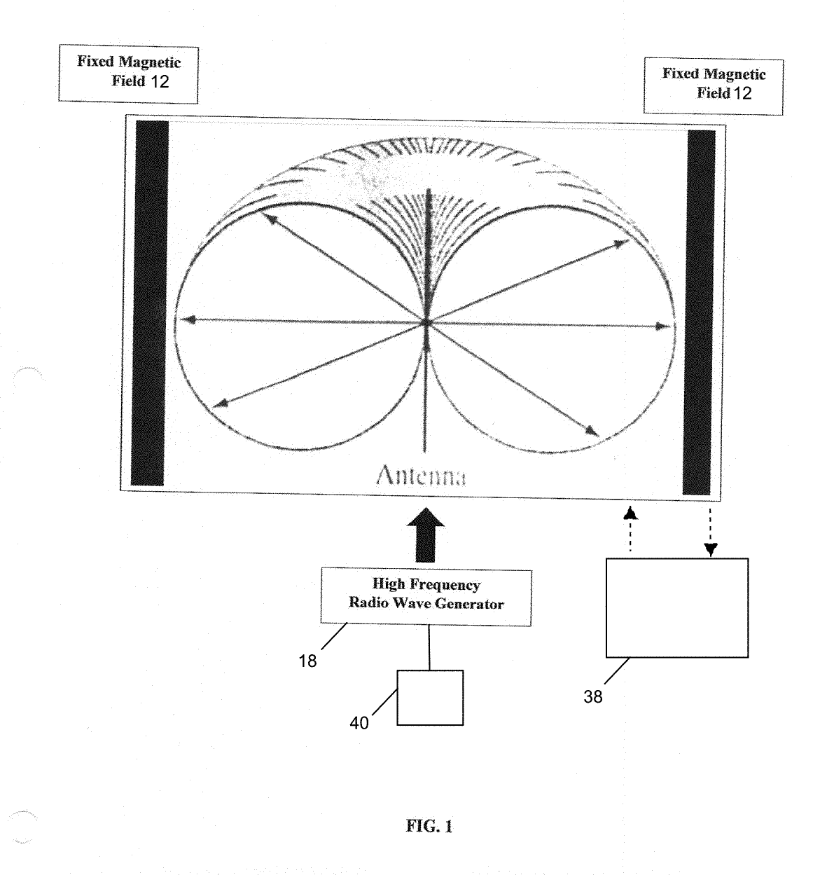

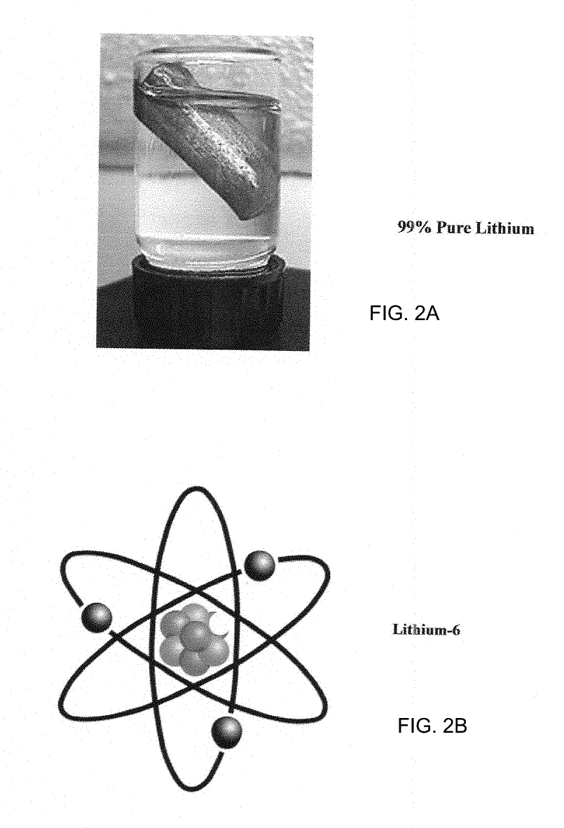

10.0 4.314
   In one embodiment, Resonant Frequency is transmitted to Urea by an antenna tuned to ¼^{th} of the wavelength of 4.314 MHz. The wavelength is 695.41 cm, and the ¼ antenna is 34.77 cm (13.689 in.). Electromagnets, in disc shape, are positioned above and below the reactor to form a fixed magnetic field. The magnets can, by way of a non-limiting example, be constructed of Neodymium Iron Boron (No Fe B). The magnets are positioned with the South Pole on a lower surface of the magnet above the reactor and the North Pole on an upper surface of the magnet below the reactor. The magnetic fields are positioned so that the antenna is perpendicular to the discs. The antenna configuration relative to the magnetic fields 12 generated is shown in FIG. 1. This resonant field is perpendicular to the fixed magnetic field generated by two electromagnetic discs, also indicated at 12. The antenna 18 is tuned to deliver the exact resonant frequency after it has been generated by a Transceiver delivering 1 to 25 watts. The strength of the fixed magnetic field 12 is adjusted to pair the fields by varying the applied voltage by use of a dual channel variable DC voltage from a Power Supply 40.

Unconventional Pairing Combination of Resonant Nuclear Frequencies (RNMF) and Strong Magnetic Field (SMF). The pairing combination of Resonant Nuclear Frequencies (RNMF) and Strong Magnetic Field (SMF) in the present invention differs from the pairing combination used in resonance spectral analysis applications. In spectral analysis, it is well known that resonance of Nitrogen-15 occurs at discrete pairs of Resonant Nuclear Magnetic Frequencies (RNMF) in the MHz range when paired with Strong Magnetic Fields (SMF) above one Tesla. The underlying principle is that the momentum of the Nitrogen-15 or any element or isotope with a few neutrons is unequal to the number of protons and can have only two orientations. This principal explains the splitting of spectral lines into three subsidiary lines in what is referred to as the Zeeman Effect. These lines correspond to quantum jumps, spin flip, in which angular momentum, along the dipole magnetic field is increased by one unit, decreased by one unit, or stays the same.

In the present embodiment of the invention, energy requirements are reduced when the quantum jump of Nitrogen-15 is uniquely made to occur at a discrete pairing combination of RNMF in the 1.000 MHz to 4.314 MHz range with SMF below one Tesla (10,000 gauss).

Shown in FIG. 7A are the first three pairing combinations of resonant nuclear magnetic frequency (RNMF) and Strong Magnetic Field (SMF), and a chart of RNMF as a function of SMF is provided in FIG. 7B. One will note how consistent the calculated ratio of SMF to RNMF is with an average ratio of 2.317890.

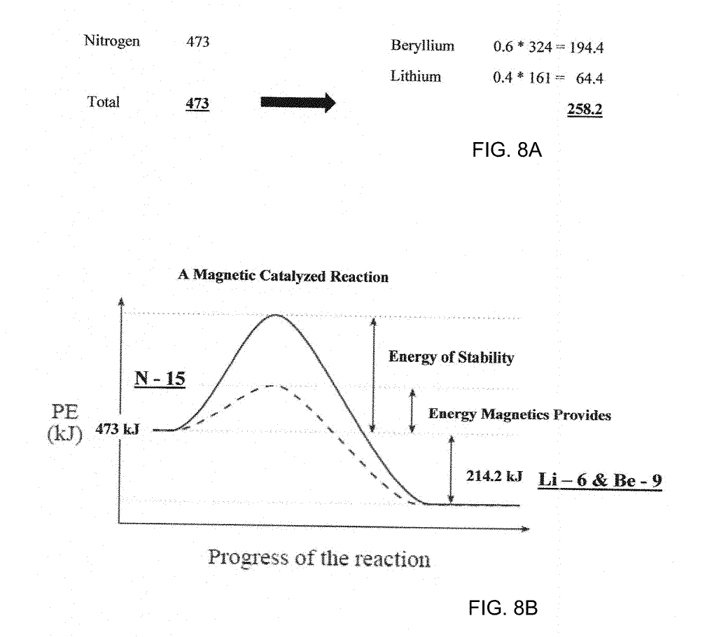

Turning to FIG. 8A, one can perceive the standard enthalpies of formation and multiplications thereof for Nitrogen, Beryllium, and Lithium. More particularly, FIG. 8A depicts the predicted molar conversion of Nitrogen-15 to Beryllium-9 and Lithium-6. FIG. 8B charts a magnetic catalyzed reaction with an analysis of Strong Magnetic Field (SMF) to Resonant Nuclear Magnetic Frequency (RNMF) data and an extension into a range employed in an embodiment of the present invention. As disclosed herein, the value of 2.31780 is used to determine the Strong Magnetic Field (SMF) required for Nitrogen-15 to resonate and be paired in a combination of frequencies in the 1.000 MHz to 4.314 MHz range. Operating in these reduced ranges of fixed magnetic and resonant frequencies provides an elegant solution to accomplish the required energy operating in these paired magnetic fields for de-stabilization of Nitrogen-15 to be accomplished with minimal power to fuel the magnetics.

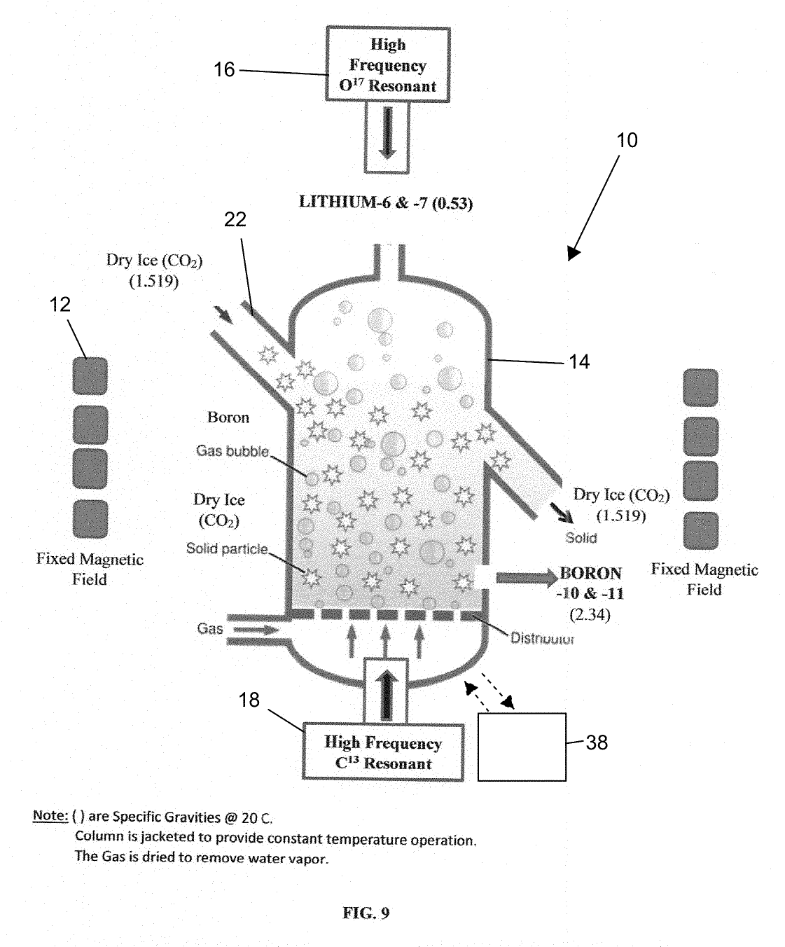

Non-limiting embodiments of systems according to the present invention are schematically shown in FIGS. 9A through 11B, where each light-nuclei element generation system is indicated generally at 10. It will be understood that numerous other manifestations of the system and method are possible.

In each light-nuclei element generation system 10, a strong, fixed magnetic field 12 surrounds at least one vessel 14. The vessel 14 contains source materials and Light-Nuclei Element (LNE) product(s). The geometric configuration of the system 10 places Carbon, Nitrogen, and Oxygen (CNO) source materials in the strong fixed magnetic field 12. The fixed magnetic field 12 is disposed orthogonally to an intelligent NMR signal(s) produced by one or more generators 16. A circulating fluid subsystem, which is schematically depicted at 38, maintains constant temperature within the system 10.

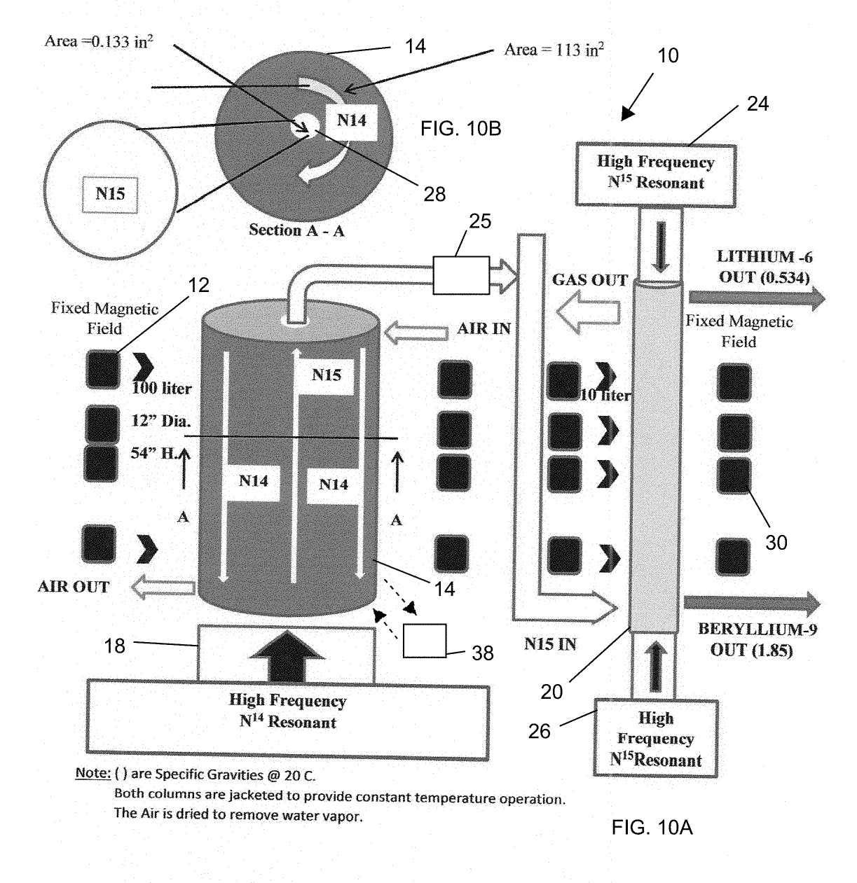

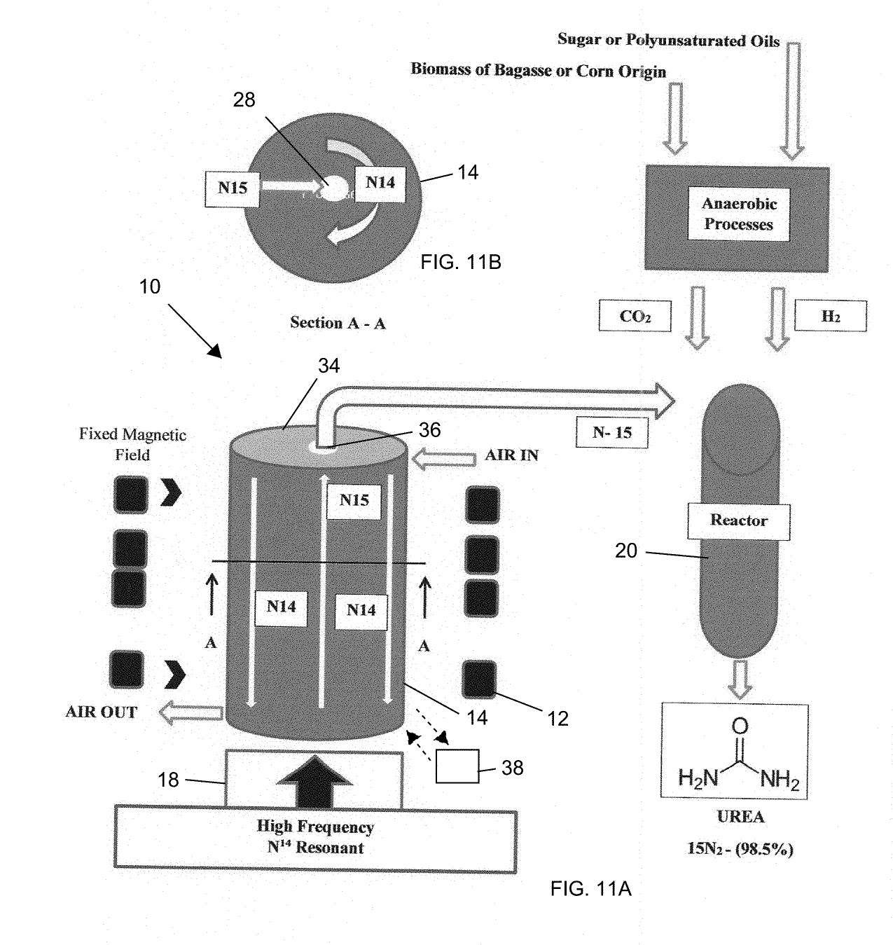

In the light-nuclei element generation system 10 of FIG. 9, the source material is a solid. In the light-nuclei element generation system 10 of FIG. 10A, the source material is a gas. Finally, in the light-nuclei element generation system 10 of FIG. 11A, the source material is a liquid.

In the embodiment of the light-nuclei element generation system 10 of FIG. 10A, a liquefaction device 25 is disposed between the output of the first vertical cylinder vessel 14 and the input to a second vertical cylindrical vessel 20 to liquefy the gaseous source material.

In the light-nuclei element generation system 10 of FIG. 9, the process comprises the manufacture of Lithium and Boron are output through the application of dry ice manufactured from source material Carbon-13 and Oxygen-17. One vertical cylindrical vessel 14 is employed wherein the source material comprises Dry Ice composed of Carbon-13 and Oxygen-17 is supplied. Within the cylindrical vessel 14, the stable elements in the Dry Ice are made unstable by exposure to high-frequency radio waves provided by intelligent NMR signal generator(s) 16 tuned to the nuclear NMR frequencies of Carbon-13 and Oxygen-17. Through this process, Lithium-6 & Lithium-7 and Boron-10 & Boron-11 are output from the source material.

High frequency signal generators 16 and 18 are located above and below the cylindrical vessel 14 to apply high frequency radio waves at the nuclear magnetic resonant (NMR) frequency of the targeted Carbon-13 and Oxygen-17 materials. The high frequency signal generator 16 located above the cylindrical vessel 14 is tuned to the NMR of Oxygen-17 to introduce instability to the Oxygen-17 in the Dry Ice source material and to produce the LNE's: Lithium-6 & Litium-7 and Boron-10 & Boron-11. The high frequency signal generator 18 located below the cylindrical vessel 14 is tuned to the NMR of Carbon-13 to introduce instability to the Carbon-13 in the Dry Ice source material and to produce the LNE's Lithium-6 and Litium-7.

In certain embodiments of the present invention, the cylindrical vessel 14 is surrounded by a fixed magnetic field 12 with a strength of 10 kilo Gauss. The high-frequency signal generator 16 located above the cylindrical vessel 14 delivers energy at 5.772 MHz, the NMR frequency for Oxygen-17, and the high frequency signal generator 18 located above the cylindrical vessel 14 delivers energy at 10.705 MHz, the NMR frequency for Carbon-13.

In certain exemplary embodiments of the system 10, the volume of the cylindrical vessel 14 is 100 liters. The vessel 14 can, for instance, be one foot in diameter with a sidewall of 54 inches in height.

In one practice of the method, Dry Ice is introduced into the cylindrical vessel 14 in snow-like form, such as through an aperture 22 that can be referred to as a snow horn 22 as in FIG. 9. The snow horn 22 could, for example, be approximately 3.5 inches in diameter. The snow-like Dry Ice can be condensed into a dense core of Dry Ice. For instance, the axial facing inward Laplace Force that is generated by the confining strong magnetic field 12 that surrounds the Dry Ice can be harnessed. This core of Dry Ice when targeted by the high frequency signal generators 16 and 18 located above and below the cylindrical vessel 14 effectively transfers the energy to the targeted source materials and produces the isotopes of Lithium and Boron.

The difference in signs of the dipole magnetic moments (DMM) of the components of the mixture augments gravity so that vertical travel is not only based on the difference in specific gravity of the materials. In the cylindrical vessel 14, when the difference in the specific gravity of the LNEs: Lithium-6 and Lithium-7 and Boron-10 and Boron-11 is 77.3%, the differences in all the positive DMM, as shown in FIG. 6, adds separation. Lithium-6 and Lithium-7 are driven upward in the direction of one magnetic pole of the fixed magnetic field 12, and Boron-10 & Boron-11 are driven downward in the direction of the other magnetic pole of the fixed magnetic field 12.

Turning more particularly to FIGS. 10A and 10B, a further embodiment of the light-nuclei element generation system 10 and the process for light-nuclei generation can be understood. There, Lithium-6 and Beryllium-9 are manufactured from Nitrogen-15 after being separated from dry air. In this embodiment of the system 10, first and second vertical cylindrical vessels 14 and 20 are employed. The first vertical cylindrical vessel 14 separates and concentrates Nitrogen-15 from dry, moisture free air. The second vertical cylindrical vessel 20 is disposed in series with the first vertical cylindrical vessel 14. In the second cylindrical vessel 20, Nitrogen-15, a stable isotope of Nitrogen, is made unstable by NMR frequency high-frequency radio waves produced by high-frequency signal generators 24 and 26 thereby producing Lithium-6 and Berrylium-9. In one illustrative but non-limiting example of the system 10, the volume of the first cylindrical vessel 14 is 100 liters, and the first vessel 14 is one foot in diameter with a side wall of 54 inches in height. The volume of the second cylindrical vessel 20 can, for instance, be approximately 10 liters.

High-frequency signal generators 18, 24, and 26 are positioned to apply high frequency radio waves at the resonant frequency of the targeted materials. In the first vertical cylindrical vessel, the high frequency signal generator 18, which in this example is located below the vertical cylindrical vessel 14, is tuned to the NMR frequency of Nitrogen-14. The output pattern of the signal generator 18 floods an annulus-shaped cross section of the column to exert a Laplace Force axial facing force to separate the heavier isotope Nitrogen-15 and to concentrate it in a central core 28 of the cylindrical vessel 14. The cross-sectional area of the central core 28 relative to the total cross section of the cylindrical vessel 14 is, in one example, 0.133 square inches out of a total area of 113 square inches. This ratio of areas approximates the relative abundance of Nitrogen-15, as according to FIG. 3 for example, at 0.37% of the total Nitrogen.

In the second vertical cylindrical vessel 20, a pair of equal high frequency signal generators 24 and 26, respectively located above and below the vessel 20, are tuned to the NMR frequency of Nitrogen-15 to introduce instability to the Nitrogen-15 source material and to produce the LNEs of Lithium-6 and Beryllium-9. In this embodiment, each vertical cylindrical vessel 14 and 20 is surrounded by a fixed magnetic field, respectively indicated at 12 and 30. The fixed magnetic fields 12 and 30 can, for example, have a strength of 10 kilo Gauss. The high frequency signal generator 16 located below the first vertical cylindrical vessel 14 can deliver energy at 3.076 MHz, the NMR frequency for Nitrogen-14. The pair of high frequency signal generators 24 and 26 located above and below the second cylindrical vessel 20 can each deliver energy at 4.314 MHz, the NMR frequency for Nitrogen-15.

In both vertical cylindrical vessels 14 and 20, the difference in signs of the respective dipole magnetic moments (DMM) of the component of the mixture augment gravitational separation. Consequently, vertical travel is not solely based on the difference in specific gravity of the materials. In the first vertical cylindrical vessel 14, when the difference in atomic weight of Nitrogen-15 and Nitrogen-14 is only 7%, the positive DMM of Nitrogen-14 of 0.40376 differs from the negative DMM of Nitrogen-15 of 0.28318 with a total difference in DMM of 0.68694. This difference in DMM drives added separation. Nitrogen-15 is driven upward in the direction of one magnetic pole of the fixed magnetic field 12, and Nitrogen-14 is driven downward in the direction of the other magnetic pole of the fixed magnetic field 12. In the second cylindrical vessel 20, when the difference in specific gravity between Lithium-6 and Beryllium-9 is 71%, the positive DMM of Lithium-6 of 0.82204 differs from the negative DMM of Beryllium-9 of 1.1778 with a total difference in DMM of 1.99984. This difference in DMM drives added separation. The Lithium-6 is driven upward in the direction of one magnetic pole of the fixed magnetic field 30, and the Beryllium-9 is driven downward in the direction of the other magnetic pole of the fixed magnetic field 30.

A still further embodiment of the light-nuclei element generation system 10 and the process for light-nuclei generation can be understood with reference to FIGS. 11A and 11B. Under the depicted practice of the system 10, Lithium-6 and Beryllium-9 are manufactured from Nitrogen-15 after being separated from dry air. First and second vertical cylindrical vessels 14 and 20 are employed. The first vertical cylindrical vessel 14 is the site of separation and concentration of Nitrogen-15 from dry, moisture free, air. The second vertical cylindrical vessel 20 is disposed in series with the first vertical cylindrical vessel 14. In the second vertical cylindrical vessel 20, Nitrogen-15, a stable isotope of Nitrogen, is made unstable by NMR frequency high-frequency radio waves by a high frequency signal generator. Through the application of the high-frequency radio waves, Lithium-6 and Berrylium-9 are produced.

In such embodiments of the system 10, liquid Urea (C(═O) (N H₂)₂) can be used as a Nitrogen source with each Nitrogen as the heavy isotope of Nitrogen-15 with an atomic weight of 15. By way of example and not limitation, Urea Source material is available from Barry Associates, 2N-15, part number IN 5792. This form of Urea, which is 98.5% pure dual Nitrogen-15 (15N₂-98.5%), is used in Nitrogen uptake studies that parallel the way the C¹⁴/C¹² isotope ratio is used in Carbon dating. Urea-2 Nitrogen-15 is commercially available in 99% Purity. Urea is made for Carbon Dioxide and Ammonia where Nitrogen-15 participates in the biochemical and chemical reaction just as Nitrogen-14 participates.

It is known that anaerobic biochemical processes are a route toward the production of Urea by sugar or polyunsaturated oils and biomass of bagasse or corn origin as source materials. The sugar or polyunsaturated oils are a food source producing predominately Carbon Dioxide. Biomass of bagasse or corn origin are food sources for Ammonia and Hydrogen to react with Nitrogen-15 obtained from the atmosphere using technology from the present invention to produce Urea. With this knowledge, the present inventor has devised that the preparation of source material may involve the application of Anaerobic Technology in the laboratory with a scale up to production. The work of the Swedish researcher Phillip B. Pope can be applied to shape the insights into anaerobic possibilities into production realities. For instance, pure Carbon Dioxide that can be produced from neat Voila, supplemented with nutrients by clostridium botulinum. A green alternative, using 10% to 20% of the energy used by electrolysis, is Hydrogen produced by Acidogenic bacteria from corn biomass, using catalytic thermal reformation. The urea cycle discovered by Krebs and Heneleit in 1932, five years before the TCA Cycle, is a biochemical reaction that occurs in many animals that produces Urea ((NH₂)₂CO) from Ammonia (NH₃). Once the Urea is prepared, it is used as a liquid feedstock using essentially the same system 10 as in FIGS. 10A and 10B to produce Lithium-6 and Beryllium-9.

In an embodiment of the light-nuclei element generation process using the system 10 shown in FIGS. 11A and 11B, Urea is confined to an annulus of one-inch height and a volume of 100 milliliters, where destabilization of Nitrogen-15 occurs with a Coil Antenna three inches long placed inside the annulus to act as the generator 18 of RNMF in the 1.000 MHz to 4.314 MHz range. The generator 18 is paired with one to three Halbach magnets placed on the outside of the annulus that supply the strong magnetic field 12 in the 0.2317 Tesla to 1.0000 Tesla range. The second vessel 20, operative as the reactor, is constructed from Heavy Wall Borosilicate Glass Tubing of various lengths of 1 ¾ inches, 1 inch, and ⅜ inch outside diameters. These three sized tubes are arranged with a single concentric long axis.

In practices of the light-nuclei element generation process, Source Material, such as Nitrogen-15, containment with the two magnetic fields, the Resonant Nuclear Frequencies (RNMF), and the Strong Magnetic Field (SMF) are supported by fluid suitable for maintaining a constant temperature. For instance, a constant temperature of 180.5° C. may be employed to maintain the Source Material and the Lithium Product as liquids and to produce resonance at a stable frequency of the Nitrogen-15 once it is established by exposure to a paired combination of RNMF and SMF.

The Geometry of a particular system 10 starting from the outermost annulus and working inward may be described as follows. A Halbach Type Strong Magnetic Field Magnet 12, 10,663 Gauss (1.0663 Tesla) BrMax, in an Annulus of 2 inches OD×1¾ inches ID by 1 inch thick, is formed from eight 45 degree Magnets of NdFeB, (N42SN) material that provides a single axis magnetic field and an operating temperature of 150 degrees Celsius. The Annulus is a magnetic field produced by arranging the wedge-shaped permanent magnets in a 45 degree orientation in a circular pattern to form the annulus with an outer and inner ID. This arrangement enhances the exhibited magnetic strength by increasing the efficiency of the magnetic circuit. The Halbach magnets 12 exhibit only one working face while the magnetic field is established by completing a magnetic circuit. This surface is the ID of the Annulus and facing inward to the central axis. In such embodiments of the system 10, one Halbach Magnetic Annulus can be formed around and concentrically located, one inch of length, on the circumference of the 1 ¾ inch Glass Tubing. The pairing of RNMF and SMF can be gross-tuned by decreasing the Strong Magnetic Field by the addition of lengths of the Halbach Magnetic Annulus. These Annuluses are located either above or above and below the centrically located first Annulus. This concept of adding magnets to decrease the magnetic strength may initially be considered counterintuitive but has been determined to be effective by the present inventor.

A thermal jacket annulus 34, which forms a portion of the circulating fluid subsystem 38 maintains constant temperature within the system 10. The thermal jacket annulus 34 is filled with circulating high temperature oil of the circulating fluid subsystem 38 with hose connections on inlet and outlet and barbs for ¼ inch ID PTFE tubing. The cross-sectional area of the Annulus 34 is 344.7 mm² or 87.6 ml per inch of height of the Thermal Jacket Annulus 34. The Temperature for the reaction is maintained at slightly above the melting of Lithium (357° F. (180.5° C.). This temperature allows the Urea to be in the liquid phase by exceeding its melting point of 271.4° F. (133° C.). High temperature oil is circulated in a closed system 38 through the reactor's Thermal Jacket Annulus 34 in a closed circulation system 38. The temperature of operation of 180.5° C. is below the recommended maximum temperature for high temperature for the high temperature oil of 230° C. for an open circulating system. A Reaction Zone Annulus 36 is filled with Urea in a liquid state to a height of one inch with the centerline of the Reaction Zone Annulus 36 height located at the centerline of the height of the Strong Magnetic Field 12. The cross-sectional area of the Reaction Zone Annulus 36 is 370.1 mm² or 94 ml per inch.

The system 10 can employ High Frequency Coil Antennas 24 and 26, 1-5 MHz, ¼ Wavelength to transmit a Signal between 1 MHz and 5 MHz at power of 1 Watt to 100 Watts. The Coil Antenna has an Air Core and is contained in a glass cylinder 3 inches in height and 9.5 mm OD, 5.5 mm ID, +/−0.4 mm with a cross-sectional area of 23.7 mm². In such embodiments of the invention, fine tuning of the pairing combinations of RNMF and SMF can be accomplished by transmitting frequencies in the range of 1 MHz to 5 MHz. The antenna transmits the desired frequency as it resonates when the capacitive resistance and the inductive resistance, which are determined by the physical properties of the antenna and the environment in which the antenna is located, cancel each other out. The wavelength in centimeters is equal to 3000 divided by the frequency in Mhz. By applying this equation, it is determined that the wavelength of the 4.314 MHz HF signal, the resonant frequency for Nitrogen-15 in a one Tesla strength Fixed Magnetic Field 12, is 695.4 centimeters. The antenna is a ¼ wave length device designed to resonate at 25% of the frequency or 25% of the length of the wavelength or 173.85 cm. The required length of the wire for the antenna is obtained by coiling the wire in an overall 3″ length of the antenna. The antenna is made by wrapping wire on a custom designed and fabricated mandrel.

Course adjustment of the pairing of SMF and RNMF can be accomplished by selecting SMF starting with one 1″ Thick Halbach Magnet 12 and reducing the field, as required, by the addition of one Halbach Magnet 12 above and one Halbach Magnet 12 below the starting Halbach Magnet 12. Fine adjustment to the pairing of SMF and RNMF is accomplished by selecting RNMFs between 1.000 MHz to 4.314 MHz from the Signal Generator 18 connected to the Coil Antenna.

The light-nuclei element generation system 10 and the process for light-nuclei generation of FIGS. 11A and 11B produces Lithium and Beryllium from liquid Urea source material from Nitrogen-15. As in FIG. 8A, the predicted equation is that each mole of Nitrogen-15 produces 0.6 moles of Beryllium-9 and 0.4 moles of Lithium-6. Based on the First Law of Thermodynamics applied to this closed system and using the enthalpy of formation of the elements, the calculation of FIG. 8A is obtained, all in Kilo joules per mole. An exothermal reaction is indicated with the energy of the products, Lithium and Beryllium, being less than the energy of the reactant, Nitrogen. This change is the energy released, which is 214.2 kilo joules per mole of Nitrogen reacted.

The pairing combination of Resonant Nuclear Frequencies (RNMF) and Strong Magnetic Field (SMF) in the present invention, for the embodiment shown in FIG. 7, differ from the pairing combination used in resonance spectral analysis applications. In spectral analysis, it is well known that resonance of Nitrogen-15 occurs at discrete pairs of Resonant Nuclear Frequencies (RNMF) in the MHz range when paired with Strong Magnetic Fields (SMF) above one Tesla. The underlying principal is that the momentum of the Nitrogen-15 or any element or isotope with a few neutrons is unequal to the number of protons and can have only two orientations. This principal explains the splitting of spectral lines into three subsidiary lines under the Zeeman Effect. These lines correspond to quantum jumps, spin flip, in which angular momentum along the dipole magnetic field is increased by one unit, decreased by one unit, or stays the same. Under the present embodiment of the invention, energy requirements are reduced when the quantum jump of Nitrogen-15 is uniquely made to occur at a discrete pairing combination of RNMF in the 1.000 MHz to 4.314 MHz range with SMF below one Tesla, 10,000 Gauss.

The temperature and conditions for the reactor produce molten Lithium and provide a constant temperature with a discrete pairing of RNMF and SMF. An alternative to separation of Nitrogen-15 from Nitrogen-14 shown in FIG. 10A is to directly utilize the Nitrogen Source provides as Urea (C(═O) (N H₂)₂) with each Nitrogen being the heavy isotope of Nitrogen-15 with an atomic weight of 15. The mole percent by weight of Nitrogen-15 in the Urea is 48.3% (30/62.06×100). The temperature of the reaction is maintained at just above 357° F. (180.5° C.), the melting point of Lithium. This temperature allows the Urea to be in the liquid phase by exceeding its melting point of 271.4° F. (133° C.). High temperature Silicon Oil is circulated in a closed circulation system around the thermal jacket 34.

A vertical cylindrical vessel 14 shown in FIG. 9 separates and concentrates the Nitrogen-15 from dry, moisture free, air. A Magnetron 18 located below the vertical cylindrical vessel 14 is tuned to the NMR frequency of Nitrogen-14 so that the output pattern floods an annulus shaped cross section of the column to exert the Laplace Force axial facing force to separate the heavier isotope Nitrogen-15 and concentrate it in a central core 28 of the cylindrical vessel 14. The cross-sectional area of the central core 28 relative to the total cross section of the cylindrical vessel 14 is 0.37% of the total cross-sectional area. This ratio of areas approximates the relative abundance of Nitrogen-15, at 0.37% of total Nitrogen as shown in FIG. 3. The fixed magnetic field 12 with a strength of 10 kilo Gauss is paired with a magnetron 18 delivering energy at 4.314 MHz, the Nuclear Magnetic frequency for Nitrogen-15 to resonate.

The difference in signs of the respective dipole magnetic moments (DMM) of the components of the mixture augment gravitational separation so that vertical travel is not solely based on the difference in specific gravity of the materials. The difference in atomic weight of the Nitrogen-15 and Nitrogen-14 is only 7%. However, separation is added by the positive DMM of Nitrogen-14 of 0.40376 from the negative DMM of Nitrogen-15 of 0.28318 for a total difference in DMM of 0.68694. This difference in DMM drives Nitrogen-15 upward in the direction of South magnetic pole of the fixed magnetic field 12 while Nitrogen-14 is driven downward in the direction of the North magnetic pole of the fixed magnetic field 12.

The foregoing corresponds to the separation of light-nuclei elements as they approach Earth in cosmic rays and are exposed to the Earth's dipole magnetic field. As the light-nuclei elements approach Earth, Lithium-6 with a positive Magnetic Dipole Moment (+0.82204) is attracted to the Earth's South Magnetic Pole and is deposited in the Southern Hemisphere and Beryllium-9 with a negative Magnetic Dipole Moment (−1.1778) is attracted to the Earth's North Magnetic Pole and is deposited in the Northern Hemisphere.

As in FIG. 10A, a Reactor 20 under the present invention can have its long axis oriented vertically. The South Pole of its fixed magnetic field 30 is oriented at the top of the Reactor 20, and the North Pole of the fixed magnetic field 30 is oriented at the bottom of the Reactor 20. The difference in specific gravity between Lithium-6 and Beryllium-9 is 71%. Gravity separation is augmented by the fact that the positive Dipole Magnetic Moment (DMM) of Lithium-6 of 0.82204 differ from the negative DMM of Beryllium-9 of 1.1778 with a total difference in DMM of 1.99984. This difference in DMM drives separation with Lithium-6 driven upward in the direction of the South magnetic pole of the fixed magnetic field 30 while the Beryllium-9 is driven downward in the direction of North magnetic pole of the fixed magnetic field 30.

In another embodiment of the system 10, a NMR Spectrometer 18, with flow through pumping, is employed. By way of a non-limiting example, one NMR Spectrometer 18 is available from Thermo Fisher Scientific, Model picoSpin Series II with Accessory Pump, Part Numbers 912A0913 and 840-267100. The spectrometer 18 is tuned to the Resonant Frequency of Nitrogen-15 molecule pairs in a Urea compound operating at nominally 8 MHz and paired with a Fixed Magnetic Field 12 of two Tesla. The product is passed through a Second Column Reactor 20 where the fixed magnetic field dipole is such as to have Beryllium and Lithium produced migrate and concentrate to their respective favored poles for removal. The stream of Urea can then be recycled for another pass through the NMR Spectrometer 18.

The NMR Spectrometer 18 can have a relatively small sample volume of 100 nanometers and can have sufficient magnetic power to excite the Nitrogen-15 elemental component in Urea to achieve the requisite instability according to the disclosed process. For instance, the NMR spectrometer 18 by producing energy density of a magnitude that exceeds 10⁵ kilo Joules per mole.

The Second Column Device 20, with its long axis oriented vertically, has the South Pole of its fixed magnetic field 30 oriented at the top and the North Pole of the fixed magnetic field 30 oriented at the bottom. The gravity separation of the reaction products, Lithium-6 and Beryllium-9, are augmented by the difference in the Magnetic Dipole Moment (1.99984) that is responsible for dispatching the Lithium-6 to the top of the reactor 20 and the Beryllium-9 to the bottom of the reactor 20. The non-temperature corrected values of specific gravities of the liquid Urea reactant is 1.32, the lighter Lithium-6 product is 0.534, and the heavier product of Beryllium-9 is 1.85. A Faraday cage (not shown) can be used to encase the Second Column Unit 20 because the dipole magnet field orientation of the reactor 20 is the reverse that of the Earth.

With certain details and embodiments of the present invention for a light-nuclei element synthesis system and process disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall be considered to define the scope of protection to be afforded to the inventor. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all equivalents thereof, including those that already exist or that may hereafter be developed.

I claim as deserving the protection of Letters Patent:

1. A method for the synthesis of light-nuclei elements (LNEs) and separation of a mixture of materials containing the light-nuclei elements and carbon, nitrogen, and oxygen (CNO) source material with a strong magnetic field, the method comprising:
providing at least one vessel for containing the mixture of materials, the mixture of materials including a source material;
providing a fixed, strong magnetic field that surrounds the at least one vessel;
imparting a high-frequency radio wave signal to the mixture contained within the at least one vessel wherein the high-frequency radio wave signal is imparted at a fixed frequency corresponding to a resonant frequency of a targeted material within the mixture of materials to induce a resonance of the targeted material and an increased energy level in the targeted material within the mixture of materials; and
removing at least some of the targeted material as a light-nuclei element product material from the mixture of materials within the vessel after resonance of the targeted material has been induced.

2. The method of claim 1 wherein the at least one vessel comprises a cylindrical vessel with a longitudinal axis wherein the longitudinal axis of the at least one vessel is disposed vertically.

3. The method of claim 2 wherein the magnetic field has a longitudinal axis wherein the longitudinal axis of the magnetic field is aligned with the longitudinal axis of the at least one vessel.

4. The method of claim 1 wherein the high-frequency radio wave signal is operative to induce a precession of the targeted material.

5. The method of claim 1 wherein the step of removing at least some of the targeted material from the mixture of materials within the at least one vessel includes separation of materials within the mixture of materials comprises separation based on differences in signs of dipole magnetic moments of materials within the mixture of materials in augmentation of differences in specific gravity of each component to enhance gravitational separation of the materials within the mixture of materials.

6. The method of claim 1 wherein the fixed, strong magnetic field is operative to produce an inward Laplace Force.

7. The method of claim 1 further comprising regulating a temperature within the at least one vessel to a substantially constant temperature by operation of a circulating fluid system.

8. The method of claim 1 wherein the mixture of materials is continuously introduced into the at least one vessel to initiate motion in a vortex pattern in the at least one vessel.

9. The method of claim 1 wherein the step of removing at least some of the targeted material from the mixture of materials within the at least one vessel comprises continuously and uniformly removing targeted material aided by the dipole magnetic moment of the targeted material within the mixture of materials.

10. The method of claim 9 further comprising continuously and uniformly removing residual material from the mixture of materials within the at least one vessel aided by differences in dipole magnetic moments of the targeted material and the residual material.

11. The method of claim 1 wherein the light-nuclei element product material comprises Lithium-6 and Lithium-7 and Boron-10 and Boron-11 and wherein the source material comprises Carbon-13 and Oxygen-17 and wherein high-frequency radio wave signals are imparted at corresponding nuclear magnetic resonant frequencies for the source material.

12. The method of claim 11 wherein the Carbon-13 and Oxygen-17 are in the form of Dry Ice with a density increased by a Laplace Force generated by the strong magnetic field operative to allow continuous exposure of the Dry Ice to high-frequency radio wave energy at the nuclear magnetic resonant frequencies of the Carbon-13 and Oxygen-17.

13. The method of claim 11 wherein the step of removing at least some of the targeted material from the mixture of materials within the at least one vessel includes separation of materials within the mixture of materials comprises separation based on differences in signs of dipole magnetic moments of materials within the mixture of materials in augmentation of differences in specific gravity of each component to enhance gravitational separation of the materials within the mixture of materials wherein the differences in signs of dipole magnetic moments of materials within the mixture of materials comprises a difference in specific gravity of the Lithium-6 & Lithium-7 and Boron-10 & Boron-11 of 77.3%, wherein all dipole magnetic moments of the materials within the mixture of materials are positive, wherein Lithium-6 & Lithium-7 are driven upward in the direction of one magnetic pole of the fixed magnetic field, and wherein the Boron-10 & Boron-11 are driven downward in the direction of an opposite magnetic pole of the fixed magnetic field.

14. The method of claim 1 wherein the fixed magnetic field has a strength of at least approximately 10 kilo gauss and wherein the high-frequency radio wave signal is provided by a high-frequency signal generator located above the vessel generated at approximately 5.72 MHz, the NMR frequency for Oxygen-17, and by a high-frequency signal generator located below the vessel generated at approximately 10.705 MHz, the NMR frequency for Carbon-13.

15. The method of claim 1 wherein the mixture of materials includes Nitrogen-15 and wherein the high-frequency radio wave signal is operative to induce a quantum jump of the Nitrogen-15 at a discrete pairing combination of a resonant nuclear magnetic frequency range between 1.000 MHz to 4.314 MHz range and a strong magnetic field of below 10,000 Gauss.

16. The method of claim 1 wherein the at least one vessel comprises a first vessel and a second vessel fluidically connected in series to the first vessel.

17. The method of claim 16 wherein the source material comprises Nitrogen-15 wherein the Nitrogen-15 is separated and concentrated in the first vessel and wherein the high-frequency radio wave signal is imparted to the Nitrogen-15 within the second vessel to produce Lithium-6 and Berrylium-9 as light-nuclei element product material.

18. The method of claim 17 wherein the source material comprises Nitrogen-15 from air in moisture free form reacted with Carbon Dioxide and Hydrogen produced by anaerobic processes to produce Urea 15N₂ in a liquid state.

19. The method of claim 1 wherein the source material comprises Nitrogen-15 in gaseous form produced during anaerobic or aerobic decomposition of liquid or solid waste where the Nitrogen-15 to Nitrogen-14 ratio by weight is greater than the ratio found in the Earth's atmosphere.

20. The method of claim 1 wherein the source material comprises Nitrogen-15, wherein the at least one vessel comprises a first vessel and a second vessel fluidically connected in series to the first vessel wherein the high-frequency radio wave signal is provided by a high-frequency signal generator located below the first vessel, wherein the high-frequency signal generator is tuned to the nuclear magnetic resonant frequency of Nitrogen-14 to be applied to an annulus-shaped cross section of the first vessel to exert a Laplace Force axial facing force that separates Nitrogen-15 and concentrates it in a central core of the first vessel, wherein first and second Magnetrons are respectively located above and below the second vessel, and wherein the first and second Magnetrons are tuned to the nuclear magnetic resonance of Nitrogen-15 to introduce instability to the Nitrogen-15 source material to produce Lithium-6 and Beryllium-9.

21. The method of claim 1 wherein the at least one vessel comprises a first vessel and a second vessel fluidically connected in series to the first vessel, wherein the first and second vessels are surrounded by a fixed magnetic field with a strength of approximately 10 kilo Gauss, wherein the wherein the high-frequency radio wave signal is provided by a high-frequency signal generator located below the first cylindrical vessel to deliver energy at 3.076 MHz, the NMR frequency for Nitrogen-14, and wherein a pair of high frequency signal generators are located above and below the second vessel, each signal generator operative to deliver energy at 4.314 MHz, the NMR frequency for Nitrogen-15.

22. The method of claim 21 wherein the step of removing at least some of the targeted material from the mixture of materials within the at least one vessel includes separation of materials within the mixture of materials comprises separation based on differences in signs of dipole magnetic moments of materials within the mixture of materials in augmentation of differences in specific gravity of each component to enhance gravitational separation of the materials within the mixture of materials wherein the differences in signs of dipole magnetic moments of materials within the mixture of materials wherein, in the first vessel, while the difference in atomic weight of the Nitrogen-15 and Nitrogen-14 is 7%, a positive dipole magnetic moment of Nitrogen-14 of 0.40376 differs from a negative dipole magnetic moment of Nitrogen-15 of 0.28318 with a total difference in dipole magnetic moment of 0.68694 in dipole magnetic moments to augment separation by driving the Nitrogen-15 upward in the direction of one magnetic pole of the fixed magnetic field and driving the Nitrogen-14 downward in the direction of the other magnetic pole of the fixed magnetic field, and wherein, in the second vessel, while the difference in specific gravity between Lithium-6 and Beryllium-9 is 71%, a positive dipole magnetic moment of Lithium-6 of 0.82204 differs from a negative dipole magnetic moment of Beryllium-9 of 1.1778 with a total difference in dipole magnetic moment of 1.99984 to augment separation by driving the Lithium-6 upward in the direction of one magnetic pole of the fixed magnetic field and driving the Beryllium-9 downward in the direction of the opposite magnetic pole of the fixed magnetic field.

23. The method of claim 22 wherein the mixture of materials includes Nitrogen-15 and wherein the high-frequency radio wave signal is operative to induce a quantum jump of the Nitrogen-15 at a discrete pairing combination of a resonant nuclear magnetic frequency range between 1.000 MHz to 4.314 MHz range and a strong magnetic field of below 10,000 Gauss.

24. The method of claim 1 wherein the magnetic field applies magnetic energy to heavy Nitrogen through orthogonally-positioned poloidal and toroidal magnetic fields to compress the distance between positive charged nucleons to a point of separation where Electrostatic Repulsion Force exceeds Strong Nuclear Force attractive force to exert a net force equal to or greater than 10⁸ KJ/mol.
